(19) United States
(12) Patent Application Publication
(10) Pub. No.: US 2015/0220348 A1
(43) Pub. Date: Aug. 6, 2015

(54) COMPUTING SYSTEM INITIATION

(71) Applicant: Bluedata Software, Inc., Mountain View, CA (US)

(72) Inventors: Thomas A. Phelan, San Francisco, CA (US); Michael J. Moretti, Saratoga, CA (US); Gunaseelan Lakshminarayanan, Cupertino, CA (US)

(21) Appl. No.: 14/493,933

(22) Filed: Sep. 23, 2014

Related U.S. Application Data
(60) Provisional application No. 61/935,540, filed on Feb. 4, 2014.

(51) Int. Cl. G06F 9/44

(52) U.S. Cl. CPC G06F 9/4416

(57) ABSTRACT

Systems, methods, and software described herein facilitate the implementation of discrete machines in a distributed data processing environment. In one example, one or more new computing devices may attempt to join the environment by transferring a Preboot Execution Environment (PXE) request to an administration system. The administration system is configured to receive the request and, in response to the request, identify boot preferences corresponding to the PXE request. The administration system is further configured to transfer boot information to the one or more computing devices based on the boot preferences.

### RELATED APPLICATIONS

This application is related to and claims priority to U.S. Provisional Patent Application No. 61/935,540, entitled “COMPUTING SYSTEM INITIATION,” filed on Feb. 4, 2014, and which is hereby incorporated by reference in its entirety.

### TECHNICAL FIELD

Aspects of the disclosure are related to computing hardware and software technology, and in particular to initializing a new computing device in a cluster computing system.

### TECHNICAL BACKGROUND

An increasing number of data-intensive distributed applications are being developed to serve various needs, such as processing very large data sets that generally cannot be handled by a single computer. Instead, clusters of computers are employed to distribute various tasks, such as organizing and accessing the data and performing related operations with respect to the data. Various applications and frameworks have been developed to interact with such large data sets, including Hive, HBase, Hadoop, Amazon S3, and CloudStore, among others.

At the same time, virtualization techniques have gained popularity and are now commonplace in data centers and other environments in which it is useful to increase the efficiency with which computing resources are used. In a virtualized environment, one or more virtual machines are instantiated on an underlying computer (or another virtual machine) and share the resources of the underlying computer. However, even with the increased efficiency provided by the virtual machines, it may still be necessary to dynamically increase the number of computing devices in the cluster to provide efficient operations on the data.

### OVERVIEW

Provided herein are systems, methods, and software for initiating computing devices in a computing environment. In one example, a method of operating an administration system to initialize new discrete computing devices includes receiving a Preboot Execution Environment (PXE) request from one or more computing devices. The method further includes identifying boot preferences corresponding to the PXE request, and transferring boot information to the one or more computing devices based on the boot preferences.

In another instance, a computer apparatus to initiate new computing devices includes processing instructions that direct an administration system to receive a PXE request from one or more computing devices. The processing instructions further direct the administration system to identify boot preferences corresponding to the PXE request, and transfer boot information to the one or more computing devices based on the boot preferences. The computer apparatus further includes one or more non-transitory computer readable media that store the processing instructions.

In a further example, a cluster computing environment includes one or more computing devices configured to transfer a PXE request to an administration system. The administration system is configured to receive the PXE request from the one or more computing devices. The administration system is further configured to identify boot preferences corresponding to the PXE request, and transfer boot information to the one or more computing devices based on the boot preferences.

This Overview is provided to introduce a selection of concepts in a simplified form that are further described below in the Technical Disclosure. It should be understood that this Overview is not intended to identify key features or essential features of the claimed subject matter, nor is it to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a system for implementing new discrete machines using an administration system.

FIG. 2 illustrates a method of operating an administration system to implement new discrete machines.

FIG. 3 illustrates an overview of initiating discrete machines in a computing environment.

FIG. 4 illustrates an administration computing system configured to implement new discrete machines in a computing environment.

FIG. 5 illustrates a timing diagram for initializing a discrete machine in a computing environment.

FIG. 6 illustrates a system for implementing a discrete machine using multiple administration systems.

FIG. 7 illustrates a timing diagram for initializing a discrete machine in a computing environment.

FIG. 8 illustrates a timing diagram for initializing a discrete machine in a computing environment.

FIG. 9 illustrates an overview of initiating discrete machines in a computing environment.

FIG. 10 illustrates a method of operating an administration system to implement new discrete machines in a computing environment.

### TECHNICAL DISCLOSURE

Data-intensive distributed applications often require more than one physical computer to process large data sets. In some examples, the plurality of computers required may further include virtualization techniques, such as virtual machines, to further maximize the processing capabilities of the physical machines. These physical computers and virtual machines may employ a variety of frameworks to process the data required for the given tasks including Hive, HBase, Hadoop, Amazon S3, and CloudStore, amongst other possible frameworks.

In some instances, the task that needs to be processed requires a greater number of physical computing devices than are currently operational. Thus, it may be necessary to initiate additional physical computers and provide them with the necessary software, virtual machines, and the like that are necessary to perform the required task. To accomplish the initialization of additional computers in the computing environment, an administrating node or computing system may be used that provides a Preboot Execution Environment or PXE. A PXE is an environment to boot computers using a network interface independently of data storage devices or installed operating systems.

In one instance, if a new physical computer or node is initiated within the computing environment, the new physical node is configured to contact the PXE administrator for the computing environment. To accomplish this task, the new physical computer may first determine the Internet Protocol (IP) address for the PXE administrator from a DHCP server. Once determined, the new physical computer may then inquire the PXE administrator using the provided IP address.

In one example, responsive to the inquiry from the new physical computer, the PXE administrator is configured to identify and transfer boot configuration data in the form of a PXE response to the new physical computer. This boot configuration data includes the files and other necessary elements to be installed on the new machine. In some instances, during or after the transfer of the boot configuration data, a user of the administrating computer system may input boot preferences for the initiating new devices. As a result, the user may verify the operating system, the applications, the number of virtual machines, the specific jobs for the new computing device, and any other relevant boot configuration data element for the computing device. Once verified, a boot command may be transferred to the new computing systems to initialize an installation using the boot configuration data.

In some examples, if the user boot preferences do not verify the boot configuration data that was passed to the new computing device, the new computing device may be configured to transfer a secondary PXE request. This secondary PXE request may be directed to the same administration system or a different administration system to gather new boot configuration data consisting of applications, virtual machines, and the like.

In another PXE environment example, once a PXE request is transferred to the administration system, the administration system may wait for user input before providing boot information to the new computing device. Accordingly, if the user authenticates a boot configuration for the new discrete device, boot configuration data may be transferred to the discrete device for installation. In contrast, if the user does not approve of the boot configuration, a boot disapproval command may be transferred to the new device, which allows the new device to transfer a second PXE request. Thus, the boot information from the administration system may include boot configuration data, as well as boot commands that are based on the user input.

In some examples, rather than receiving user input to verify the boot configuration data, an automated process may approve the data for the booting device. For example, the administration system may be configured with internet protocol (IP) or media access control (MAC) addresses for computing devices that are approved for boot configuration data. If a requesting device has the appropriate IP or MAC address, the administration system may initiate an installation by transferring boot configuration data. However, if the IP or MAC address is not approved, the administration system may transfer a boot disapproval command, requiring the new computing device to transfer a secondary PXE request.

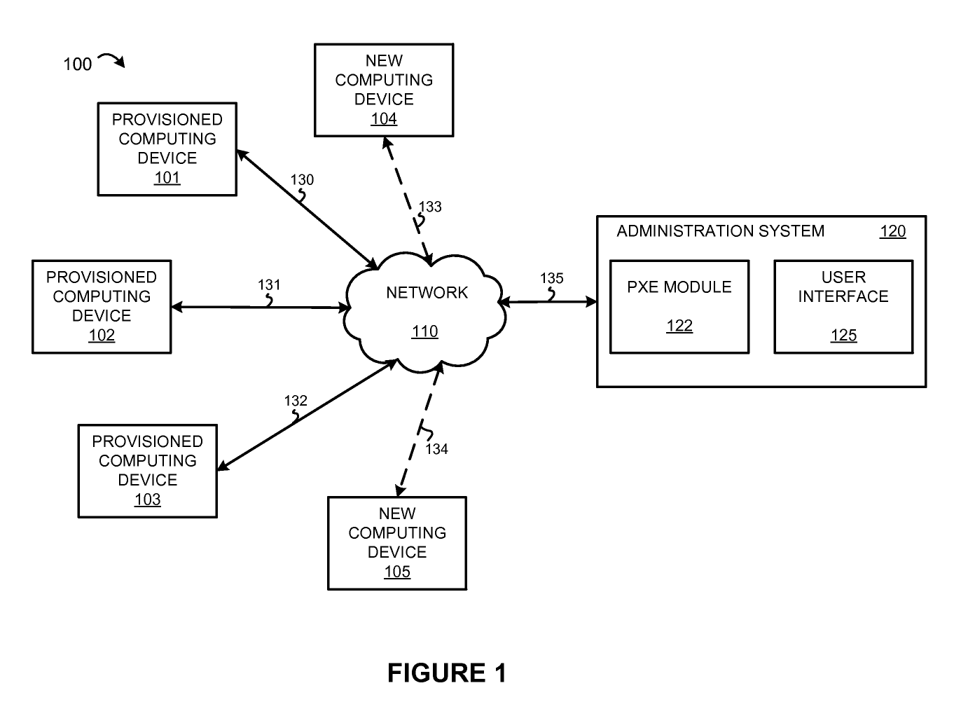

To further illustrate the operation of the administration computing system, FIG. 1 is included that illustrates a system 100 for initializing new discrete machines in a computing environment. System 100 includes administration system 120, provisioned computing devices 101-103, new computing devices 104-105, and network 110. Administration system 120 further includes PXE module 122 and user interface 125. Provisioned computing devices 101-103 and new computing devices 104-105 are configured to communicate with network 110 over communication links 130-134. Network 110 is further configured to communicate with administration system 120 over communication link 135.

Provisioned computing devices 101-103 and new computing devices 104-105 may comprise any physical computing system with the ability to process data in a distributed application environment. Computing devices 101-105 may include processing systems, user interfaces, communication interfaces, storage systems, or other similar computing elements. Computing devices 101-105 may include server computers, desktop computers, laptop computers, or any other similar computing device.

Administration system 120 may include any computing device or collection of devices capable of configuring computing devices 101-105. Administration system includes PXE module 122 and user interface 125, but may further include processing systems, storage systems, and communication interfaces. Administration system 120 may include one or more server computers, desktop computers, laptop computers, or any other similar computing device-including combinations thereof.

Network 110 is configured to provide communication services to networked devices 101-105 and to allow the devices to connect to administration system 120. Network 110 may comprise switches, access nodes, Internet routers, network gateways, application servers, computer systems, communication links, or some other type of communication equipment-including combinations thereof.

Communication links 130-135 use metal, glass, air, space, or some other material as the transport media. Communication links 130-135 could use various communication protocols, such as Time Division Multiplex (TDM), Internet Protocol (IP), Ethernet, communication signaling, Code Division Multiple Access (CDMA), Evolution Data Only (EVDO), Worldwide Interoperability for Microwave Access (WIMAX), Global System for Mobile Communication (GSM), Long Term Evolution (LTE), Wireless Fidelity (WIFI), High Speed Packet Access (HSPA), or some other communication format-including combinations thereof. Communication links 130-135 could be direct links or may include intermediate networks, systems, or devices.

In operation, provisioned computing devices 101-103 may be used in a data intensive distributed framework that allows data tasks to be processed across multiple machines. In some examples, computing devices 101-103 include one or more virtual machines that are further used to maximize the processing capabilities of each computing device. The frameworks employed by these virtual machines may include Hive, HBase, Hadoop, Amazon S3, and CloudStore, among others.

Although computing devices 101-103 may be able to process the data tasks without the help of additional computing resources, further computing devices may ensure a quicker or more efficient result for the defined tasks. Accordingly, new computing devices 104-105 may be initiated by an administrator or some other process to help in processing the tasks in the distributed framework.

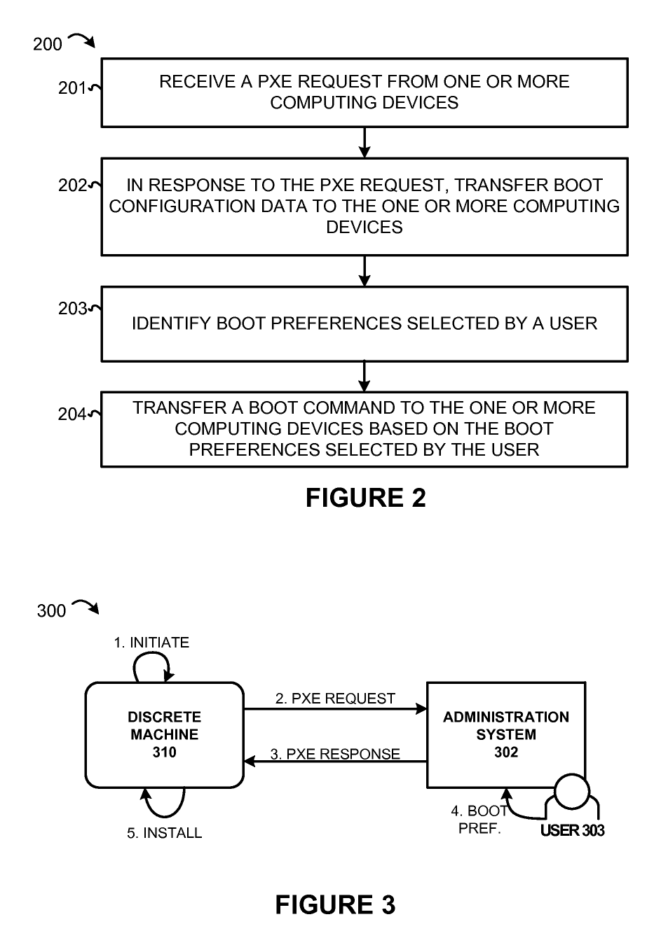

To further illustrate the initiation of new computing devices 104-105, FIG. 2 is included that illustrates a method 200 of operating administration system 120. In operation, administration system 120 is configured to identify a PXE request from one or more computing devices using PXE module 122 (201). Using system 100 as an example, new computing devices 104-105 are configured to join the distributed data processing system represented by provisioned computing devices 101-103. To join the system, computing devices 104-105 must first determine the IP address for administration system 120. In some examples, new computing devices 104-105 may already possess the IP address for administration system 120, and as a result may contact administration system 120 directly. In other instances, new computing devices 104-105 may be required to contact a Dynamic Host Configuration Protocol (DHCP) server to retrieve the appropriate IP address for the administration system. Once the IP address is retrieved, the new computing devices may then communicate the PXE request to administration system 120.

In response to the requests from new computing devices 104-105, PXE module 122 on administration system 120 is configured to transfer boot configuration data to the one or more computing devices (202). This boot configuration data may include the data for the virtual machines to be installed on the new machines, the applications to be installed on the new machines, the specific tasks to be assigned to the new machines, or any other relevant boot configuration. Once the configuration is passed to the new computing machines, installation using the configuration data may be held until a user of the administration system can specify boot preferences and verify the configuration (203).

Upon determination of the boot preferences by the end user, administration system 120 is configured to transfer a boot command to computing devices 104-105 based on the boot preferences selected by the user (204). In some examples, the boot command is configured to initialize the installation of the software, virtual machines, and other elements contained in the boot configuration data. In other instances, where the user does not verify the configuration data, computing devices 104-105 may be configured to initiate a new PXE request to gather new configuration data. This new configuration data may be gathered from the same administration system, or may be gathered from a different administration system accessible by the new devices.

Referring now to FIG. 3, FIG. 3 illustrates an overview 300 of initiating discrete machines in a computing environment. Overview 300 includes administration system 302, user 303, and discrete machine 310. Discrete machine 310 is an example of new computing devices 104-105, although other examples may exist.

In operation, discrete machine 310 may be initiated to assist other discrete machines in providing distributed data processing for one or more tasks. Once the machine is initiated, discrete machine 310 may provide a PXE request to administration system 302. This PXE request allows discrete machine 310 to boot using a network interface independently of data storage devices or installed operating systems. Instead, discrete machine 310 may rely on administration system 302 to provide the necessary software and boot elements for the discrete machine to operate.

Once the PXE request is identified by administration system 302, administration system 302 is configured to transfer boot configuration data to discrete machine 310 in the form of a PXE response containing various software and boot elements. Administration system 302 is further configured to gather one or more boot preferences from user 303, which may be used to verify the boot configuration data passed to discrete machine 310. These boot preferences may include the number of virtual machines to be installed on the new machine, the type of applications to be installed on the new machine, the specific tasks to be assigned to the new machine, or any other relevant boot factor. Once verified, administration system 302 may transfer a boot command to discrete machine 310 initializing installation of the elements provided in the PXE response.

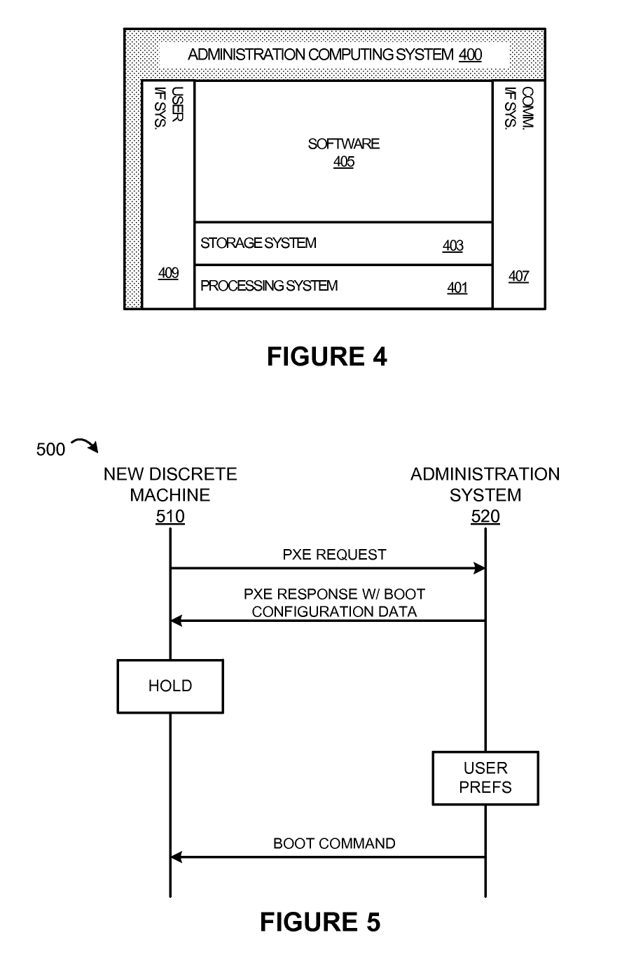

Turning now to FIG. 4, FIG. 4 illustrates an administrator computing system 400 that is representative of a computing system that may be employed in any computing apparatus, system, or device, or collections thereof, to suitably implement administration system 120, as well as process 200, and administration system 302, or variations thereof. Computing system 400 may be employed in, for example, server computers, cloud computing platforms, data centers, any physical or virtual computing machine, and any variation or combination thereof. In addition, computing system 400 may be employed in desktop computers, laptop computers, or the like.

Computing system 400 includes processing system 401, storage system 403, software 405, communication interface system 407, and user interface system 409. Processing system 401 is operatively coupled with storage system 403, communication interface system 407, and user interface system 409. Processing system 401 loads and executes software 405 from storage system 403. When executed by processing system 401, software 405 directs processing system 401 to operate as described in herein with respect to administration system 120, as well as method 200, and administration system 302. Computing system 400 may optionally include additional devices, features, or functionality not discussed here for purposes of brevity.

Referring still to FIG. 4, processing system 401 may comprise a microprocessor and other circuitry that retrieves and executes software 405 from storage system 403. Processing system 401 may be implemented within a single processing device but may also be distributed across multiple processing devices or sub-systems that cooperate in executing program instructions. Examples of processing system 401 include general-purpose central processing units, application specific processors, and logic devices, as well as any other type of processing device, combinations, or variation.

Storage system 403 may comprise any computer readable storage media readable by processing system 401 and capable of storing software 405. Storage system 403 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal.

In addition to storage media, in some implementations storage system 403 may also include communication media over which software 405 may be communicated internally or externally. Storage system 403 may be implemented as a single storage device but may also be implemented across multiple storage devices or sub-systems co-located or distributed relative to each other. Storage system 403 may comprise additional elements, such as a controller, capable of communicating with processing system 401 or possibly other systems.

Software 405 may be implemented in program instructions and among other functions may, when executed by processing system 401, direct processing system 401 to operate as described herein by FIGS. 1-3. In particular, the program instructions may include various components or modules that cooperate or otherwise interact to carry out the operations described in FIGS. 1-3. The various components or modules may be embodied in compiled or interpreted instructions or in some other variation or combination of instructions. The various components or modules may be executed in a synchronous or asynchronous manner, in a serial or in parallel, in a single threaded environment or multi-threaded, or in accordance with any other suitable execution paradigm, variation, or combination thereof. Software 405 may include additional processes, programs, or components, such as operating system software, hypervisor software, or other application software. Software 405 may also comprise firmware, or some other form of machine-readable processing instructions executable by processing system 401.

For example, if the computer-storage media are implemented as semiconductor-based memory, software 405 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 400 is generally intended to represent a system on which software 405 may be deployed and executed in order to implement an administration system from FIGS. 1-3 (or variations thereof). However, computing system 400 may also be suitable for any computing system on which software 405 may be staged and from where software 405 may be distributed, transported, downloaded, or otherwise provided to yet another computing system for deployment and execution, or yet additional distribution.

In one example, one or more discrete machines may be initiated and attempt to join a data-intensive processing system or cluster. To accomplish this task, the discrete machines may contact computing system 400 at communication interface system 407 with a PXE request. The discrete machines use the request to receive software and booting instructions from the administration computing system. Once the PXE request is received by computing system 400, software 405 will direct the computing system to identify and transfer boot configuration data in the form of a PXE response. This PXE response includes the necessary files and directories to configure the virtual machines, software, and any other elements that are required in the initiation of the discrete machines.

Along with the boot configuration data, computing system 400 is also configured to identify boot preferences that are selected by the user using user interface system 409. These boot preferences may include information about whether the boot configuration data is correct, whether new boot configuration data needs to be transferred, whether a different administration system is necessary to configure the discrete machines, or any other relevant user preference. Based on these preferences, computing system 400 is configured to transfer a boot command to the discrete devices. In situations where the boot configuration data is correct, the boot command initiates the installation of the various files and other elements that are contained in the boot configuration data. However, if the boot configuration data is incorrect, the boot command may initiate a secondary PXE request to gather configuration data for the discrete devices.

Although computing system 400 is configured to receive user input to determine the boot command for the discrete devices, in some examples a default boot command may be included. As a result, a timeout may be placed on computing system 400 to initiate the default boot command when a user does not input a preference for the discrete machines. This would allow the machines to be configured despite the lack of user input.

Communication interface system 407 may include communication connections and devices that allow for communication with other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface system 409 may include a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 409. In some cases, the input and output devices may be combined in a single device, such as a display capable of displaying images and receiving touch gestures. The aforementioned user input and output devices are well known in the art and need not be discussed at length here. User interface system 409 may also include associated user interface software executable by processing system 401 in support of the various user input and output devices discussed above. Separately or in conjunction with each other and other hardware and software elements, the user interface software and devices may support a graphical user interface, a natural user interface, or any other suitable type of user interface.

Referring now to FIG. 5, FIG. 5 illustrates a timing diagram 500 for providing PXE responses to new discrete computing systems. Timing diagram 500 includes new discrete machine 510 and administration system 520. In operation, new discrete machine 510 may be initiated to join a computing cluster that processes large amounts of data. Once initiated, new discrete machine 510 is configured to transfer a PXE request to administration system 520 to gather the necessary installation files for the discrete machine.

In response to the request, administration system 520 is configured to return a PXE response that comprises boot configuration data. This boot configuration data comprises information about the virtual machines to install, the proper applications for the virtual machines, or any other relevant information to boot new discrete machine 510. During or after the transfer of files and data, new discrete machine 510 is configured to hold the installation of the new files while administration system 520 gathers preferences from a user. These preferences may include a variety of information, including whether the boot configuration data is correct and whether an alternative boot configuration is intended for new discrete machine 510.

Based on theses user preferences, a boot command is transferred to new discrete machine 510. In some examples, when the configuration is identified as correct by the end user, the boot command initiates the installation of the boot configuration data. In other instances, when the user identifies that the boot configuration is incorrect, the boot command may initiate a secondary PXE request. This PXE request may be to administration system 520 querying for an alternative configuration, or may be to an alternative administration system that posses a different configuration.

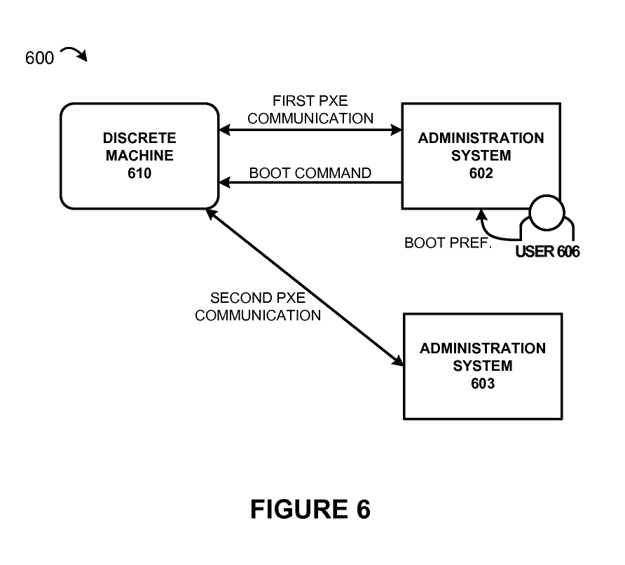

FIG. 6 illustrates a system 600 that implements discrete machines using a plurality of administration systems. System 600 includes administration systems 602-603, user 606, and discrete machine 610. In operation, discrete machine 610 may be initiated and communicate a PXE request to administration system 602. In some examples, administration system 602 may be configured as the default administration system for discrete machine 610. As a result, discrete machine 610 may be configured to contact administration system 602 immediately upon boot. In other examples, a directory computing system or DHCP server may be employed that is the initial contact for discrete machine 610. This directory computing system may then refer discrete machine 610 to administration system 602 to gather the necessary boot configuration data.

In response to the PXE request, administration system 602 is configured to transfer boot configuration data to the discrete machine. This boot configuration data may include applications, virtual machine information, or any other files or elements necessary to configure and boot discrete machine 610. Further, administration system 602 is configured to gather user preferences from user 606 and generate a boot command that may be transferred to discrete machine 610. The boot command is used in authorizing the installation of the elements provided by the boot configuration data. If the user approves of the boot configuration, then the boot command will initiate the configuration of discrete machine 610 using the configuration data. However, as illustrated in FIG. 6, if the user does not approve of the configuration, discrete machine 610 may be configured to transfer a second PXE request to gather the necessary configuration data.

In some examples, the boot command generated by the user preferences may identify the proper location for discrete machine 610 to gather the configuration data. In other instances, discrete machine 610 may refer back to the directory computing system to determine the next administration contact.

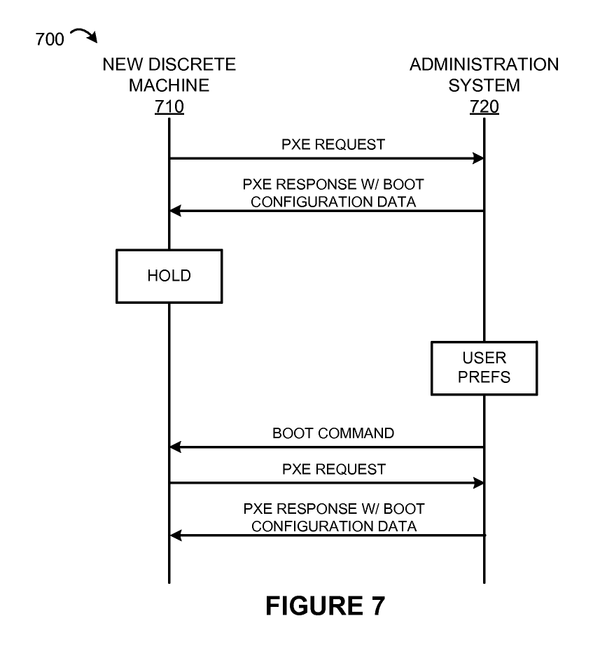

Turning to FIG. 7, FIG. 7 illustrates a timing diagram 700 for initializing a discrete machine in a computing environment. Timing diagram 700 includes new discrete machine 710 and administration system 720. Similar to the operations described above with respect to FIG. 5, new discrete machine 710 initiates a PXE request to gather configuration data for the new device. This configuration information may include files, directories, and other similar necessary elements for installing and configuration new discrete machine 710.

Once the configuration data is received by discrete machine 710, discrete machine 710 will then pause the installation process to wait for user preferences at administration system 720. For example, an administrator may be used to approve the initiated discrete machine and the boot configuration data. Accordingly, if the boot configuration data comprised an operating system, the boot approval command could be used by new discrete machine 710 to install the operating system. In contrast, as depicted in FIG. 7, the boot command may also comprise a command to disapprove of the configuration data that was delivered to new discrete machine. As a result, when the disapproval boot command is transferred from administration system 720 to new discrete machine 710, new discrete machine 710 may cancel the installation of the elements delivered with the configuration data.

Instead, new discrete machine 710 may transfer a second PXE request to administration system 720 to gather new boot configuration data in accordance with the desires of the administrator of the cluster. This new data may include a new version of an operating system, a new version of an application to be run on the new discrete machine, a change in the number or type of virtual machines, or any other similar data. In some examples, new discrete machine 710 may wait again for the administrator to provide a boot command regarding the data. However, in other instances, new discrete machine 710 may immediately initiate the installation of the appropriate files and directories.

Although illustrated in FIG. 7, as receiving user or administrator input to transfer the boot command, in some examples, administration system 720 may be configured with a timeout mechanism. This timeout mechanism may be used by administration system 720 to transfer a boot command in situations where the administrator is unavailable or automation is desired. Accordingly, once of the boot configuration data is delivered to discrete machine 710, administration system 720 may wait a predefined period of time to transfer a default boot command to new discrete machine 710 without the input of a user. In some examples, the default boot command may be based on an identifier, such as an IP or MAC address, for the requesting computing device. Thus, if the identifier for the new machine is verified, the install may continue. In contrast, if the identifier is not verified for the new machine, the installation may be canceled and the machine may be directed to transfer a second request.

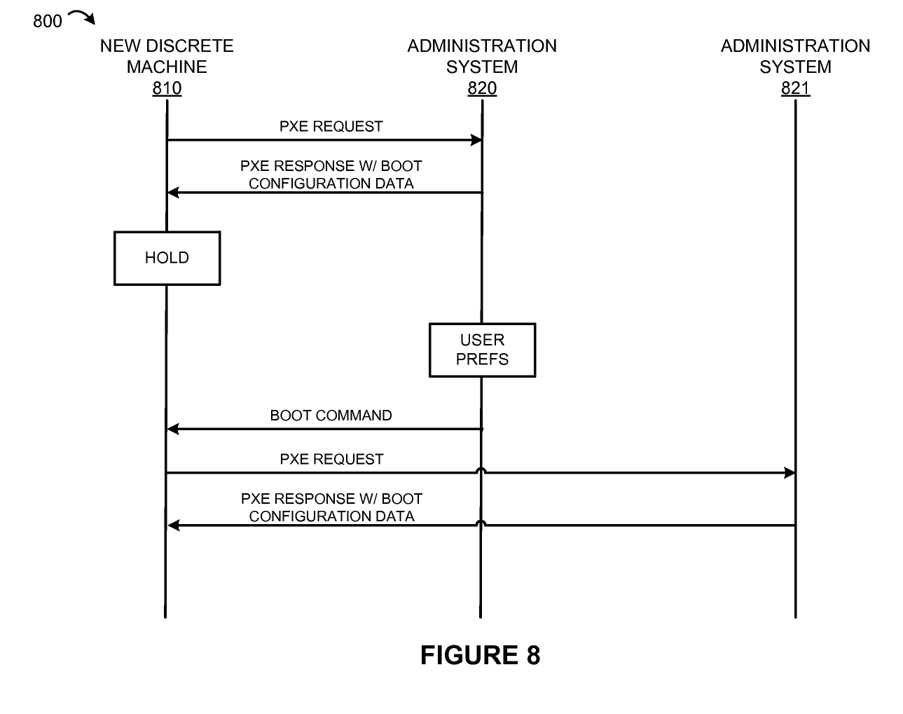

Referring to FIG. 8 as an alternative example for transferring a boot disapproval command. FIG. 8 illustrates a timing diagram 800 for initializing a discrete machine in a computing environment, such as a data processing cluster environment. Timing diagram 800 includes new discrete machine 810, and administration system 820-821. New discrete machine 810 is an example of any new computing device or discrete machine described herein.

As depicted, new discrete machine 810 initiates a PXE communication directed at administration system 820. Responsive to the communication, administration system 820 transfers a PXE response with boot configuration data for new discrete machine 810. Rather than implementing the boot configuration data immediately, new discrete machine 810 will hold or wait for user preferences to be entered at administration system 820. In some examples, the user preferences generated at administration system 820 include verification or approval input regarding the boot configuration data. In other examples, the input may include specific changes to the configuration data, such as a change in the operating system, a change in the number of virtual machines provisioned for the discrete machine, a change in the applications applied in the discrete machine, or any other similar input.

Once the input is received from the user, a boot command is delivered to new discrete machine 810 based on the user preferences. If the user confirms the configuration data that was sent to new discrete machine 810, then the boot command may be used to initiate the various elements included in the boot configuration data. In contrast, as depicted in FIG. 8, if the boot command does not approve or confirm the configuration data, the installation of the elements associated with the configuration data may be canceled. Instead, new discrete machine 810 may identify a second administration system 821 to gather necessary boot configuration data. Administration system 821 may be a backup boot configuration machine, may be a machine that was identified in the boot command at administration system 820, or may be any other machine in the cluster environment. Once the PXE request is received by administration system 821, administration system 821 transfers new boot configuration data to new discrete machine 810. In some examples, based on the preferences established at administration system 820, the new boot configuration data may be automatically installed from administration system 821. In other instances, new discrete machine 810 will hold until user preferences can be received to verify the new boot configuration data. Once verified, the elements associated with the boot configuration data may be installed, such as operating systems, virtual machines, applications, or any other necessary elements for the new discrete machine.

Although illustrated in previous examples as requiring input from an administrator, it should be understood that default boot commands might be included in administration systems 820-821. Accordingly, based on a timeout mechanism or other similar process, a default boot command may be delivered to the new discrete machines as they are initiated. These default boot commands may include commands to initiate the installation of the elements associated with the boot configuration data, a command to cancel the installation of the elements associated with the boot configuration data, a command to transition to an alternative administration system, or any other default mechanism. In some examples, rather than being a default mechanism, administration system 820 may be configured to automatically verify new discrete machine 810. Accordingly, administration system 820 may use the internet protocol (IP) address, the media access control (MAC) address, or some other identifier of the new device to verify the configuration. If the IP or MAC address for the device is verified, then the installation will be approved. If, however, the IP or MAC address is not verified for the boot configuration data, then the new discrete machine may be redirected to an alternative administration system.

Although described in FIGS. 1-8 as transferring the boot configuration data to the computing devices prior to or during the receipt of user input, it should be understood that the boot configuration data might be transferred in response to receiving the user input. For example, one or more computing devices may transfer a PXE request to an administration system. Responsive to the request, the administration system may wait to receive user input regarding the PXE request, such as an approval or disapproval to install predefined boot configuration data. Once the user input is received, boot information may be transferred to the computing devices to either install the defined boot configuration data or cancel the installation process. In other examples, rather than waiting for user input, the administration system may be configured to automatically verify the device requesting to join a cluster. To accomplish this task, the administration system may use the IP address, MAC address, or some other identifier for the requesting device to determine if the device is approved to install the boot configuration data. If it is approved, the data will be transferred and installed, however, if the device is not approved, the installation may be cancelled and the device may be redirected to an alternative administration system.

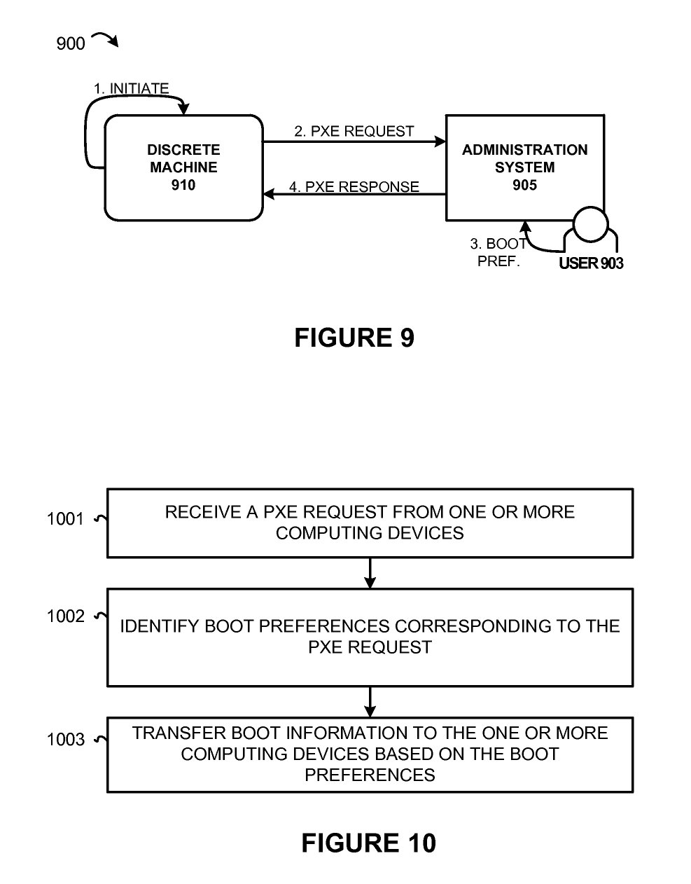

Turning to FIG. 9 as an example, FIG. 9 illustrates an overview 900 of initiating discrete machines in a computing environment. Overview 900 includes administration system 905 and discrete machine 910. In operation, administration system 905 may provide one or more discrete machines with boot information to allow operating systems, virtual machines, and other applications or processes to be installed remotely to the discrete machines.

As depicted in the present instance, discrete machine 910 is initialized within a cluster environment, and requires a configuration to join the cluster environment. Accordingly, discrete machine 910 is configured to transfer a PXE request to administration system 905. In some examples, discrete machine 910 may be preconfigured with the address for administration system 905. However, in other instances, discrete machine 910 may contact a DNS server to identify the location of the administration system. Once the location is identified, the PXE request may be delivered to administration system 905.

In response to receiving the PXE request, administration system 905 identifies boot preferences from user 903 that correspond to the PXE request. These boot preferences may include verification of boot configuration data to be provided to the discrete machine. For instance, administration system 905 may include a predefined installation configuration that is to be provided to discrete machines. Accordingly, if the predefined installation configuration is intended for new discrete machine 910, the user may approve the installation, and boot configuration data may be transferred to discrete machine 910 in the form of a PXE response. In contrast, if user 903 does not approve of the installation, a boot command may be delivered that cancels the installation using administration system 905. In some examples, upon receiving the cancel installation command, discrete machine 910 may be directed to an alternative administration system to send a PXE request. This alternative administration system may include an alternative installation configuration for the newly initiated computing device. Thus, by having multiple administration systems within a cluster environment, different configurations may be available to new devices to configure the devices for particular tasks or jobs.

Although illustrated in the present example as receiving user input, it should be understood that the verification of new discrete machine 910 might be done automatically by administration system 905. For example, administration system 905 may use the IP or MAC address for discrete machine 910 to verify the device. If the IP or MAC address is approved the boot configuration data will be transferred for installation. In contrast, if the IP or MAC address is not approved, then a response will be delivered that cancels the installation of the data, and further may direct discrete machine 910 to an alternative administration system to gather the data necessary for installation.

As a further illustration of configuring discrete machines. FIG. 10 is included. FIG. 10 illustrates a method of operating an administration system to implement new discrete machines in a computing environment. As depicted, the method includes receiving a PXE request from one or more computing devices (1001). This PXE request is used by the one or more computing devices to gather boot configuration data from the administration system for installation. The method further includes, identifying boot preferences corresponding to the PXE request selected by a user (1002), and transferring boot information to the one or more computing devices based on the preferences selected by the user (1003).

In some examples, upon receiving the PXE request, the administration system transfers predefined boot configuration data to the initiated computing devices, where the data is stored in memory until a boot command is transferred from the administration system. During or after the transfer of the boot configuration data, the administration system may receive or identify boot preferences selected by a user or administrator of the computing environment. Based on the preferences, a boot command may be transferred to the one or more computing devices. If the user approves the boot configuration data transferred to the new computing devices, a boot approval command is transferred and the boot configuration data that is loaded into memory may be installed to the new computing devices. In contrast, if the user does not approve of the boot configuration data transferred to the new computing devices, a boot disapproval command may be transferred to the new computing devices to cancel the installation of the boot configuration data that was being loaded into memory.

In another example, rather than transferring the boot configuration data to the new computing devices before receiving user input, the boot configuration data may be held until the boot preferences are identified from the user. Accordingly, if the user approves the predefined boot configuration data, the data may be transferred to the new computing devices for installation. However, if the user does not approve of the current predefined boot configuration data, a boot disapproval command may be transferred to the computing devices. This boot disapproval command triggers the new computing devices to transfer a new PXE request, possibly to an alternative administration system.

As described above, the boot information that is provided from the administration system to the one or more computing devices may comprise boot configuration data and user commands. Accordingly, the boot information may include solely the boot configuration data when the transfer of configuration data is held until user input is received, or may comprise the boot configuration data and a boot command when the configuration data is transferred prior to receiving user input.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating an administration system to initialize new discrete computing devices, the method comprising:
receiving a Preboot Execution Environment (PXE) request from one or more computing devices;
identifying boot preferences corresponding to the PXE request; and
transferring boot information to the one or more computing devices based on the boot preferences.

2. The method of claim 1 wherein transferring the boot information to the one or more computing devices based on the boot preferences comprises transferring boot configuration data to the one or more computing devices for installation on the one or more computing devices based on the boot preferences.

3. The method of claim 1 wherein transferring the boot information to the one or more computing devices based on the boot preferences comprises transferring a boot disapproval command to the one or more computing devices based on the boot preferences.

4. The method of claim 3 wherein the boot disapproval command comprises a command for the one or more computing devices to transfer a new PXE request to an alternate administration system.

5. The method of claim 1 wherein identifying the boot preferences corresponding to the PXE request comprises identifying user selected boot preferences corresponding to the PXE request.

6. The method of claim 5 wherein transferring the boot information to the one or more computing devices based on the boot preferences comprises:
in response to receiving the PXE request, transferring boot configuration data to the one or more computing devices; and
in response to identifying the user selected boot preferences, transferring a boot command to the one or more computing devices based on the user selected boot preferences.

7. The method of claim 6 wherein the boot command comprises a boot approval command to install the boot configuration data.

8. The method of claim 6 wherein the boot command comprises a boot disapproval command to cancel installation of the boot configuration data.

9. The method of claim 8 wherein the boot disapproval command comprises a command to transfer a new PXE request to an alternate administration system.

10. A computer apparatus to initiate new computing devices, the computer apparatus comprising:
processing instructions that direct an administration computing system, when executed by the administration computing system, to:
receive a Preboot Execution Environment (PXE) request from one or more computing devices;
identify boot preferences corresponding to the PXE request; and
transfer boot information to the one or more computing devices based on the boot preferences; and
one or more non-transitory computer readable media that store the processing instructions.

11. The computer apparatus of claim 10 wherein the processing instructions to transfer the boot information to the one or more computing devices based on the boot preferences direct the administration computing system to transfer boot configuration data to the one or more computing devices for installation on the one or more computing devices based on the boot preferences.

12. The computer apparatus of claim 10 wherein the processing instructions to transfer the boot information to the one or more computing devices based on the boot preferences direct the administration computing system to transfer a boot disapproval command to the one or more computing devices based on the preferences.

13. The computer apparatus of claim 12 wherein the boot disapproval command comprises a command to transfer a new PXE request to an alternate administration system.

14. The computer apparatus of claim 10 wherein the processing instructions to identify the boot preferences corresponding to the PXE request direct the administration computing system to identify user selected boot preferences corresponding to the PXE request.

15. The computer apparatus of claim 14 wherein the processing instructions to transfer the boot information to the one or more computing devices based on the boot preferences direct the administration computing system to:
in response to receiving the PXE request, transfer boot configuration data to the one or more computing devices; and
in response to identifying the user selected boot preferences, transfer a boot command to the one or more computing devices based on the user selected boot preferences.

16. The computer apparatus of claim 15 wherein the boot command comprises a boot approval command to install the boot configuration data.

17. The computer apparatus of claim 15 wherein the boot command comprises a boot disapproval command to cancel installation of the boot configuration data.

18. The computer apparatus of claim 10 wherein the processing instructions to identify the boot preferences corresponding to the PXE request direct the administration computing system to identify automated boot preferences based on one or more identifiers that correspond to the one or more computing devices.

19. A cluster computing environment comprising:
one or more computing devices configured to:
transfer a Preboot Execution Environment (PXE) request to an administration system;
the administration system configured to:
receive the PXE request from the one or more computing devices;
identify boot preferences corresponding to the PXE request; and
transfer boot information to the one or more computing devices based on the boot preferences.

20. The cluster computing environment of claim 1 wherein the administration system configured to identify boot preferences corresponding to the PXE request is configured to identify user selected boot preferences corresponding to the PXE request.
